(19) United States
(12) Patent Application Publication
(10) Pub. No.: US 2011/0123859 A1
(43) Pub. Date: May 26, 2011

(54) Polymer Electrolytes

(75) Inventors: Biying Huang, Camarillo, CA (US); Hieu Duong, Rosemead, CA (US); Monica Meckfessel Jones, Simi Valley, CA (US); George Adamson, Camarillo, CA (US); Donald Sadoway, Cambridge, MA (US)

(73) Assignee: ZPower, Inc., Camarillo, CA (US)

(21) Appl. No.: 12/934,287

(22) PCT Filed: Mar. 27, 2009
(86) PCT No.: PCT/US2009/001887

§ 371 Date: Jan. 26, 2011

Related U.S. Application Data
(60) Provisional application No. 61/039,975, filed on Mar. 27, 2008.

(51) Int. Cl. H01M 10/02

(52) U.S. Cl. 429/206

(57) ABSTRACT

The present invention provides improved electrochemical devices formed from a cathode, an anode, and a liquid electrolyte formulated from at least one polymer and at least one alkaline agent. The polymer is electrically conductive and mixes with the alkaline agent to form a substantially uniform mixture.

### CROSS-REFERENCE TO RELATED APPLICATION

This patent application claims the benefit of U.S. Provisional Patent Application Ser. No. 61/039,975, filed on Mar. 27, 2008, which is hereby incorporated by reference.

### FIELD OF THE INVENTION

The present invention relates to novel electrolytes and electrochemical cells using such electrolytes.

### BACKGROUND OF THE INVENTION

Rechargeable batteries are commonly used in portable electronic devices. Typically, the batteries are charged after full or partial discharge by delivering energy to the batteries and reversing chemical processes within the batteries. This can be accomplished by applying a voltage to the batteries and/or forcing current through the batteries; thus, restoring charge. A common charging method is to apply a voltage source to the spent battery, which is greater than the battery voltage, and stop charging when the battery ceases to accept additional current. Such charging methods do not consider the state of charge of the battery at the onset of charging, and almost always result in deleterious effects on the battery, which include reduced performance and reduced battery life.

Some rechargeable batteries and such as zinc alkaline batteries and particularly zinc-silver batteries are useful due to their high power density. They possess one of the highest gravimetric and volumetric energy densities of commercially available batteries. Additionally, traditional zinc batteries possess low self-discharge rates as well as high current discharges upon demand.

Despite these advantages, traditional zinc batteries suffer a number of limitations. For example, these batteries suffer from a sharp decline in capacity with usage that results in short cycle life, e.g., lasting less than 50 cycles when subjected to field conditions with infrequent cycling, short overall service life, or both.

This sharp reduction in capacity is caused by secondary chemical reactions that occur in the zinc battery cell. These secondary chemical reactions cause the degradation of the electrolyte, a change of the scope of the anode electrode due to excessive zinc solubility in an aqueous electrolyte, a degradation of the electrode separator via silver migration and plating, and premature localized shorts due to the formation of dendrites on the zinc electrode. It is also noted that these deleterious secondary reactions can be brought about by overcharging the battery.

Therefore, improvements in battery service life, shelf life, and/or performance are achieved with efficient management of deleterious side reactions within the battery cell.

### SUMMARY OF THE INVENTION

One aspect of the present invention provides an electrolyte comprising a polymer comprising PEG; and an alkaline agent, wherein the electrolyte has a glass transition temperature of at least about −20° C., and the polymer and the alkaline agent are substantially miscible. In several embodiments, the polymer comprises PEG having a Mₙ of from about 100 amu to about 10,000 amu. In other embodiments, the electrolyte comprises a polymer of formula (I):

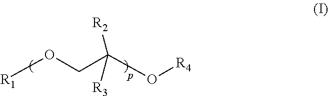

wherein each of R₂ and R₃ is independently —(V₁-Q₁)ₙ-H, wherein each V₁ is independently a bond or —O—, each Q₁ is independently a bond or a C₁₋₆ alkyl, and each n is independently 1-5; each of R₁ and R₄ is independently -(Q₂-V₂-Q₃)ₙ-H, wherein each Q₂ is independently a C₁₋₆ alkyl, each V₂ is independently a bond or —O—, and each Q₃ is independently a bond or a C₁₋₆ alkyl; and p is a positive integer of sufficient value such that the polymer of formula (I) has a total molecular weight of from about 100 amu to about 10,000 amu. In several examples, R₁ is (V₁-Q₁-V₂-Q₂-V₃-Q₃)ₙ, n is 1, each of V₁, Q₁, V₂, Q₂, and V₃ is a bond, and Q₃ is hydrogen. In other examples, R₄ is (V₁-Q₁-V₂-Q₂-V₃-Q₃)ₙ, n is 1, each of V₁, Q₁, V₂, Q₂, and V₃, is a bond, and Q₃ is hydrogen. Sometimes R₁ is (V₁-Q₁-V₂-Q₂-V₃-Q₃)ₙ, n is 1, each of V₁, Q₁, V₂, Q₂, and V₃ is a bond, and Q₃ is —CH₃. In other embodiments, the electrolyte has a glass transition temperature of at least about −15° C. Other exemplary polymers include polyethylene glycol, polypropylene glycol, polybutylene glycol, alkyl-polyethylene glycol, alkyl-polypropylene glycol, alkyl-polybutylene glycol, a copolymer thereof, or any combination thereof. In several electrolytes of the present invention, the alkaline agent comprises LiOH, NaOH, KOH, CsOH, RbOH, or any combination thereof. For instance, the electrolyte comprises from about 5 wt % to about 76 wt % of alkaline agent. In other instances, the alkaline agent further comprises KOH. And, sometimes, the electrolyte is substantially free of water. For instance, the electrolyte comprises an amount of water equaling about 60% of the weight (wt) of the alkaline agent or less.

Another aspect of the present invention provides an electrochemical cell comprising a cathode comprising silver oxide; an anode comprising Zn; and an electrolyte comprising a polymer comprising PEG, and an alkaline agent, wherein the electrolyte further comprises a glass transition temperature of at least about −20° C. In several embodiments, the polymer comprises PEG and has a mean molecular mass of from about 100 amu to about 10,000 amu. In other embodiments, the polymer comprises a polymer of formula I, as described above. In other embodiments, the electrolyte has a glass transition temperature of at least about −15° C. In some instances, the polymer comprises polyethylene glycol, polypropylene glycol, polybutylene glycol, alkyl-polyethylene glycol, alkyl-polypropylene glycol, alkyl-polybutylene glycol, a copolymer thereof, or any combination thereof. In other embodiments, the alkaline agent comprises LiOH, NaOH, KOH, CsOH, RbOH, or a combination thereof. For instance, the electrolyte further comprises more than about 5 wt % of alkaline agent. In other instances, the electrolyte further comprises from about 4 wt % to about 33 wt % of alkaline agent. In still other instances, the alkaline agent further comprises KOH. In several instances, the cathode further comprises an organometallic lead compound. In other embodiments, the anode, the cathode, or both further comprise a binder comprising PVDF, PTFE, or a copolymer thereof. In some embodiments, the electrolyte also comprises less than about 10 wt % by weight of electrolyte a small carbon chain alcohol.

Many cells of the present invention also comprise a separator that is substantially inert in the presence of the electrolyte, cathode, and anode. In some embodiments, the separator comprises a polyacid, a polyalcohol, a polyamine, a polysulfonate, or a combination thereof. In alternative embodiments, the separator comprises a PEO material or a PVA material.

The electrolyte used in some cells of the present invention comprises an amount of water totaling about 60 wt % or less.

Another aspect of the present invention provides a method of producing an electrolyte comprising providing at least one polymer comprising PEG; providing at least one alkaline agent; and combining the polymer and the alkaline agent to generate a mixture wherein the mixture has a glass transition temperature of no less than about −20° C.

Another aspect of the present invention provides a method of producing an electrochemical cell comprising providing a cathode comprising AgO; providing an anode comprising Zn; and providing an electrolyte comprising a polymer comprising PEG, and an alkaline agent.

### BRIEF DESCRIPTION OF THE FIGURES

FIG. 1 is diagram presenting a cross-sectional view of Cells A and B;

FIGS. 2A and 2B are graphs illustrating the ionic conductivity of 1.4 g/mL of aq. KOH;

FIGS. 3A and 3B are graphs illustrating the ionic conductivity of an exemplary liquid polymer including PEG-200;

FIGS. 4A and 4B are graphs illustrating the ionic conductivity of one exemplary polymer electrolyte of the present invention comprising PEG-200 and 10 wt % KOH;

FIGS. 5A and 5B are graphs illustrating the ionic conductivity of an exemplary electrolyte including PEG-200 and 50 wt % KOH by weight of electrolyte;

FIGS. 6A and 6B are graphs illustrating the ionic conductivity of an exemplary electrolyte of the present invention including PEG-dimethyl ether having a mean molecular weight of about 500 amu that is saturated with KOH;

FIGS. 7A and 7B are graphs illustrating the ionic conductivity of an exemplary electrolyte of the present invention including a slurry of PEG-Dimethyl ether having a mean molecular weight of about 500 amu and 33 wt % KOH;

FIGS. 8A and 8B are graphs illustrating the ionic conductivity of an exemplary electrolyte of the present invention comprising a slurry of PEG-Dimethyl ether having a mean molecular weight of about 500 amu and 11 wt % KOH;

FIGS. 9A and 9B are graphs illustrating the ionic conductivity of an exemplary electrolyte of the present invention including a slurry of PEG-dimethyl ether having a mean molecular weight of about 500 amu and 33 wt % KOH, that is further diluted to 11 wt % KOH with PEG-dimethyl ether having a mean molecular weight of 200 amu;

FIG. 10 is a graphical representation of life cycle data for Cell A tested at 1.4 Ah capacity using a 350 mA discharge rate and 280 mA charge rate;

FIG. 11 is a graphical representation of life cycle data for Cell B tested at 1.4 Ah capacity using a 350 mA discharge rate and 280 mA charge rate;

FIG. 12 is a picture illustrating the state of oxidation of the separator of Cell A; and

FIG. 13 is a picture illustrating the state of oxidation of the separator of Cell B.

The examples described in the figures above are by way of example only and not intended to limit the scope of the present invention.

### DETAILED DESCRIPTION

The present invention provides an electrolyte comprising a polymer and an alkaline agent, wherein the polymer and the alkaline agent are at least substantially miscible and have a glass transition temperature of at least −20° C.

### I. DEFINITIONS

As used herein, “liquid” refers to one of the four principle states of matter. A liquid is a fluid that can freely form a distinct surface at the boundaries of its bulk material. For example, a polymer may be liquid at temperatures above its T_{g} or at temperatures at least as high as its melting temperature.

As used herein, “glass transition temperature” or “T_{g}” refer to the temperature below which the physical properties of amorphous materials vary in a manner similar to those of a solid phase (glassy state), and above which amorphous materials behave like liquids (rubbery state).

As used herein, the terms “melting point”, “melting temperature”, or “Tₘ” refer to the temperature range at which a material changes state from solid to liquid. At the melting point the solid phase and liquid phase exist in equilibrium. When considered as the temperature of the reverse change from liquid to solid, it is referred to as the freezing point.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of alkaline agents. Some electrolytes also comprise additives such as buffers. For example, an electrolyte comprises a buffer comprising a borate or a phosphate. Exemplary electrolytes include, without limitation, aqueous KOH, aqueous NaOH, or the liquid mixture of KOH in a polymer.

As used herein, “polymer” refers to a molecule composed of repeating structural units, or monomers, connected by covalent chemical bonds. Examples of polymers include plastics and DNA. An exemplary polymer can comprise a liquid physical state at room temperature and/or throughout the operational temperature range of the electrochemical device in which it is stored. Other exemplary polymers include polyethylene oxides such as polyethylene glycol, polypropylene glycol, polybutylene glycol, alkyl-polyethylene glycol, alkyl-polypropylene glycol, alkyl-polybutylene glycol, or combinations thereof. Other polymers include polyacetylenes, polypyrroles, polythiophenes, polyanilines, polyfluorenes, poly-3-hexylthiophene, polynaphthalenes, poly-p-phenylene sulfide, poly-para-phenylene vinylenes, or combinations thereof. Still other exemplary polymers can have molecular weights or mean molecular weights of about 10,000 amu or less, (e.g., less than about 9,500 amu, or from about 50 amu to about 10,000 amu).

For convenience, the polymer name “polyethylene oxide” and the corresponding initials “PEO” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

For convenience, the polymer name “polyvinyl alcohol” and its corresponding initials “PVA” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

As used herein, “alkaline agent” refers to a base or ionic salt of an alkali metal. Furthermore, an alkaline agent forms hydroxyl ions when dissolved in water or other polar solvents. Exemplary alkaline agents include without limitation LiOH, NaOH, KOH, CsOH, RbOH, or combinations thereof.

For convenience, the polymer name “polyvinylidene fluoride” and its corresponding initials “PVDF” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone. One exemplary copolymer is PVDF-co-HFO, or polyvinylidene fluoride-co-hexafluoropropylene.

For convenience, the polymer name “polytetrafluoroethylene” and its corresponding initials “PTFE” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

For convenience, the polymer name “polyethyleneglycol” and the corresponding initials “PEG” are used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

As used herein, a “binder” refers to a material that when combined with other materials can form a composite material. Exemplary binders include polymers such as PTFE, PVDF, or copolymers thereof.

As used herein, “electrically conductive”, “conductive”, or “conductor” refers to materials that readily conduct electric current. Exemplary conductors include metals such as Cu, Ag, Fe, Au, Pt, Sn, Pb, Al, oxides thereof, or combinations thereof. Other exemplary conductors include polymers such as polyethylene oxides (e.g., polyethylene glycol, polypropylene glycol, polybutylene glycol, alkyl-polyethylene glycol, alkyl-polypropylene glycol, alkyl-polybutylene glycol, or combinations thereof).

As used herein, “cell” and “electrochemical cell” are used interchangeably to refer to an electrochemical cell that includes at least one anode, at least one cathode, and electrolyte.

As used herein, “miscible” refers to materials that can be combined or can dissolve into one another in many proportions without separating. For example, miscible materials can combine to form a uniform mixture when the mixture is subjected to temperatures in the range of operating or storage temperatures of an electrochemical cell (e.g., at least −20° C.).

As used herein, an “alkyl” group refers to a saturated aliphatic hydrocarbon group containing 1-8 (e.g., 1-6 or 1-4) carbon atoms. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted (i.e., optionally substituted) with one or more substituents.

When describing polymers, the term “Mₙ” is used interchangeably with “mean molecular weight”.

As used herein, “Ah” refers to Ampere (Amp) Hour and is a scientific unit for the capacity of a battery or electrochemical cell. A derivative unit, “mAh” represents a milliamp hour and is 1/1000 of an Ah.

As used herein, “maximum voltage” or “rated voltage” refers to the maximum voltage an electrochemical cell can be charged without interfering with the cell's intended utility. For example, in several zinc-silver electrochemical cells that are useful in portable electronic devices, the maximum voltage is less than about 3.0 V (e.g., less than about 2.8 V, less than about 2.5 V, about 2.3 V or less, or about 2.0 V). In other batteries, such as lithium ion batteries that are useful in portable electronic devices, the maximum voltage is less than about 15.0 V (e.g., less than about 13.0 V, or about 12.6 V or less). The maximum voltage for a battery can vary depending on the number of charge cycles constituting the battery's useful life, the shelf-life of the battery, the power demands of the battery, the configuration of the electrodes in the battery, and the amount of active materials used in the battery.

As used herein, an “anode” is an electrode through which (positive) electric current flows into a polarized electrical device. In a battery or galvanic cell, the anode is the negative electrode from which electrons flow during the discharging phase in the battery. The anode is also the electrode that undergoes chemical oxidation during the discharging phase. However, in secondary or rechargeable cells, the anode is the electrode that undergoes chemical reduction during the cell's charging phase. Anodes are formed from electrically conductive or semiconductive materials, e.g., metals, metal oxides, metal alloys, metal composites, semiconductors, or the like. Common anode materials include Si, Sn, Al, Ti, Mg, Fe, Bi, Zn, Sb, Ni, Pb, Li, Zr, Hg, Cd, Cu, LiC₆, mischmetals, alloys thereof, oxides thereof, or composites thereof.

Anodes may have many configurations. For example, an anode may be configured from a conductive mesh or grid that is coated with one or more anode materials. In another example, an anode may be a solid sheet or bar of anode material.

As used herein, a “cathode” is an electrode from which (positive) electric current flows out of a polarized electrical device. In a battery or galvanic cell, the cathode is the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, or the like. Common cathode materials include AgO, Ag₂O, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or composites thereof.

Cathodes may also have many configurations. For example, a cathode may be configured from a conductive mesh that is coated with one or more cathode materials. In another example, a cathode may be a solid sheet or bar of cathode material.

As used herein, an “electronic device” is any device that is powered by electricity. For example, and electronic device can include a portable computer, a portable music player, a cellular phone, a portable video player, or any device that combines the operational features thereof.

As used herein, “silver oxide” refers to a silver complex or molecular species such as one having the chemical formula AgO, Ag₂O₃, Ag₂O, combinations thereof, or the like.

As used herein, “cycle life” is the maximum number of times a secondary battery can be charged and discharged.

The symbol “M” denotes molar concentration.

Batteries and battery electrodes are denoted with respect to the active materials in the fully-charged state. For example, a zinc-silver oxide battery comprises an anode comprising zinc and a cathode comprising silver oxide. Nonetheless, more than one species is present at a battery electrode under most conditions. For example, a zinc electrode generally comprises zinc metal and zinc oxide (except when fully charged), and a silver oxide electrode usually comprises silver oxide (AgO and/or Ag₂O) and silver metal (except when fully discharged).

The term “oxide” applied to alkaline batteries and alkaline battery electrodes encompasses corresponding “hydroxide” species, which are typically present, at least under some conditions.

As used herein “substantially stable” or “substantially inert” refers to a compound or component that remains substantially chemically unchanged in the presence of an alkaline electrolyte (e.g., potassium hydroxide) and/or in the presence of an oxidizing agent (e.g., silver ions present in the cathode or dissolved in the electrolyte).

As used herein, “charge profile” refers to a graph of an electrochemical cell's voltage or capacity with time. A charge profile can be superimposed on other graphs such as those including data points such as charge cycles or the like.

As used herein, “resistivity” or “impedance” refers to the internal resistance of a cathode in an electrochemical cell. This property is typically expressed in units of Ohms or micro-Ohms.

As used herein, the terms “first” and/or “second” do not refer to order or denote relative positions in space or time, but these terms are used to distinguish between two different elements or components. For example, a first separator does not necessarily proceed a second separator in time or space; however, the first separator is not the second separator and vice versa. Although it is possible for a first separator to precede a second separator in space or time, it is equally possible that a second separator precedes a first separator in space or time.

As used herein, an “audio device” is an electronic device that can generate sound waves. For example, a music device (e.g., a stereo or digital music player), a portable audio alarm, a microphone, a radio (e.g., walkie talkie), or a cellular telephone.

As used herein, a “video device” is an electronic device that can generate video, such as a television, a computer and/or computer monitor, or a PDA.

It is noted that certain electronic devices are categorized as both audio devices and video devices. For example, televisions, computers, and some music players and cellular telephones can generate both sound waves and video.

As used herein, an “electrochemical device” is any device that has at least one electrochemical cell. Examples of electrochemical devices include, without limitation, batteries (e.g., rechargeable batteries), fuel cells, electrolysis and/or electroplating cells, and the like.

### II. ELECTROLYTE

One aspect of the present invention provides an electrolyte comprising a polymer and an alkaline agent, wherein the electrolyte has a glass transition temperature of at least −20° C.

Polymers useful in formulating the electrolyte of the present invention include those that are at least substantially miscible with an alkaline agent. Furthermore, these polymers, when combined with the alkaline agent, form a mixture (e.g., solution) that has a glass transition temperature of at least −20° V.

For example, in one embodiment, the electrolyte has a glass transition temperature of at least −20° C. In other examples, the electrolyte has a glass transition temperature at a temperature of at least −19° C. (e.g., at least −15° C., at least −10° C., or from about −20° C. to about 70° C.). In another embodiment, the electrolyte has a glass transition temperature from about −20° C. to about 60° C. For example, the electrolyte is liquid from about −10° C. to about 60° C.

Polymers useful for formulating an electrolyte of the present invention are also at least substantially miscible with an alkaline agent. In one embodiment, the polymer is at least substantially miscible with the alkaline agent over a range of temperatures that at least includes the operating and/or storage temperatures of the electrochemical cell in which the mixture is used. For example, the polymer is at least substantially miscible, e.g., substantially miscible with the alkaline agent at a temperature of at least −20° C. In another embodiment, the polymer is at least substantially miscible with the alkaline agent at a temperature from about −20° C. to about 60° C. For example, the polymer is at least substantially miscible with the alkaline agent at a temperature of from about −10° C. to about 60° C.

In other embodiments, the polymer is at least substantially miscible with the alkaline agent over a range of temperatures that at least includes the operating and/or storage temperatures of the electrochemical cell in which the mixture is used, when the electrolyte additionally comprises a small amount (e.g., less than about 10 wt % by weight of electrolyte, less than about 5 wt % by weight of electrolyte, or less than about 1 wt % by weight of electrolyte) of a short carbon chain alcohol (e.g., methanol, ethanol, isopropanol, or mixtures thereof). For example, the polymer is at least substantially miscible, e.g., substantially miscible with the alkaline agent at a temperature of at least −20° C. when the electrolyte additionally comprises less than about 10 wt % by weight of electrolyte of methanol, ethanol, isopropanol, or any mixture thereof.

In several embodiments, the polymer can combine with the alkaline agent at a temperature in the range of temperatures of the operation of the electrochemical cell in which is it stored to form a substantially uniform mixture.

In one embodiment, the electrolyte comprises a polymer comprising PEG. In several examples the polymer comprises PEG having a mean molecular weight of from about 50 amu to about 10,000 amu (e.g., from about 100 amu to about 10,000 amu, from about 170 amu to about 7,000 amu, or from about 180 amu to about 6,000 amu).

In one embodiment, the electrolyte comprises a polymer of formula (I):

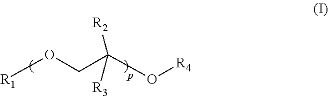

wherein each of R₁, R₂, R₃, and R₄ is independently (V₁-Q₁-V₂-Q₂-V₃-Q₃)ₙ; each of V₁, V₂, and V₃ is independently a bond or —O—; each of Q₁, Q₂, and Q₃ is independently a bond, hydrogen, or a C₁₋₆ alkyl; n is 1-5; and p is a positive integer of sufficient value such that the polymer of formula (I) has a total molecular weight of less than about 10,000 amu (e.g., less than about 5000 amu, less than about 3000 amu, from about 50 amu to about 2000 amu, or from about 100 amu to about 1000 amu) and an alkaline agent.

In several embodiments, the polymer is straight or branched. For example, the polymer is straight. In other embodiments, R₁ is independently (V₁-Q₁-V₂-Q₂-V₃-Q₃)ₙ, wherein n is 1; each of V₁, Q₁, V₂, Q₂, and V₃ is a bond; and Q₃ is hydrogen. In some embodiments, R₄ is independently (V₁-Q₁-V₂-Q₂-V₃-Q₃)ₙ, wherein n is 1, each of V₁, Q₁, V₂, Q₂, and V₃ is a bond; and Q₃ is hydrogen. In other embodiments, both of R₁ and R₄ are (V₁-Q₁-V₂-Q₂-V₃-Q₃)ₙ, each n is 1, each of V₁, Q₁, V₂, Q₂, and V₃ is a bond, and each Q₃ is hydrogen.

However, in other embodiments, R₁ is independently (V₁-Q₁-V₂-Q₂-V₃-Q₃)ₙ, wherein n is 1; each of V₁, Q₁, V₂, Q₂, and V₃ is a bond; and Q₃ is —CH₃, —CH₂CH₃, —CH₂CH₂CH₃, or H. For example, R₁ is independently (V₁-Q₁-V₂-Q₂-V₃-Q₃)ₙ, wherein n is 1, each of V₁, Q₁, V₂, Q₂, and V₃ is a bond, and Q₃ is —CH₃ or H.

In another example, R₁ is independently (V₁-Q₁-V₂-Q₂-V₃-Q₃)ₙ, wherein n is 1, one of Q₁ or Q₂ is —CH₂—, —CH₂CH₂—, or —CH₂CH₂CH₂—; V₁ and V₂ are each a bond; V₃ is —O—, and Q₃ is H.

In several other examples R₄ is independently (V₁-Q₁-V₂-Q₂-V₃-Q₃)ₙ, wherein n is 1, each of V₁, Q₁, V₂, Q₂ is a bond, and V₃ is —O— or a bond, and Q₃ is hydrogen, —CH₃, —CH₂CH₃, or —CH₂CH₂CH₃. For example, R₄ is independently (V₁-Q₁-V₂-Q₂-V₃-Q₃)ₙ, wherein n is 1, each of V₁, Q₁, V₂, Q₂, and V₃ is a bond, and Q₃ is —H, —CH₃, —CH₂CH₃, or —CH₂CH₂CH₃.

In another embodiment, R₁ is (V₁-Q₁-V₂-Q₂-V₃-Q₃)ₙ, wherein n is 1, each of V₁, Q₁, V₂, Q₂, and V₃ is a bond, and Q₃ is —CH₃, and R₄ is (V₁-Q₁-V₂-Q₂-V₃-Q₃)ₙ, wherein n is 1, each of V₁, Q₁, V₂, Q₂ is a bond, and V₃ is —O—, and Q₃ is —H.

In some embodiments, R₂ is independently (V₁-Q₁-V₂-Q₂-V₃-Q₃)ₙ, wherein n is 1, each of V₁, Q₁, V₂, Q₂, and V₃ is a bond, and Q₃ is —CH₃, —CH₂CH₃, —CH₂CH₂CH₃, or H. In other embodiments, R₂ is independently (V₁-Q₁-V₂-Q₂-V₃-Q₃)ₙ, wherein n is 1, one of V₁, Q₁, V₂, Q₂, and V₃ is —O—, and Q₃ is —H.

In some embodiments, R₃ is independently (V₁-Q₁-V₂-Q₂-V₃-Q₃)ₙ, wherein n is 1, each of V₁, Q₁, V₂, Q₂, and V₃ is a bond, and Q₃ is —CH₃, —CH₂CH₃, —CH₂CH₂CH₃, or H. In other embodiments, R₃ is independently (V₁-Q₁-V₂-Q₂-V₃-Q₃)ₙ, wherein n is 1, one of V₁, Q₁, V₂, Q₂, and V₃ is —O—, and Q₃ is —H.

In several embodiments, R₁, R₄, or both R₁ and R₄ is an alkyl group. For example, R₁ and/or R₄ is independently selected from hydrogen, a primary alkyl, a secondary alkyl, and a tertiary alkyl. In other examples, either R₁ or R₄ is bonded to the backbone of another polymer.

In some embodiments, the polymer comprises a polyethylene oxide. In other examples, the polymer comprises a polyethylene oxide comprising polyethylene glycol, polypropylene glycol, polybutylene glycol, alkyl-polyethylene glycol, alkyl-polypropylene glycol, alkyl-polybutylene glycol, a copolymer thereof, or any combination thereof.

In another embodiment, the polymer is a polyethylene oxide having a mean molecular weight of less than about 10,000 amu (e.g., less than about 5000 amu, or from about 100 amu to about 1000 amu). In other embodiments, the polymer comprises polyethylene glycol. For example the polymer comprises PEG having a Mₙ of less than about 10,000 amu (e.g., less than 5000 amu, or from about 100 amu to about 10,000 amu).

Alkaline agents useful in the electrolyte of the present invention are capable of producing hydroxyl ions when mixed with an aqueous or polar solvent such as water and/or a liquid polymer.

In some embodiments, the alkaline agent comprises LiOH, NaOH, KOH, CsOH, RbOH, or combinations thereof. For example, the alkaline agent comprises LiOH, NaOH, KOH, or combinations thereof. In another example, the alkaline agent comprises KOH.

In several exemplary embodiments, the electrolyte of the present invention comprises a polymer of formula (I) and an alkaline agent comprising LiOH, NaOH, KOH, CsOH, RbOH, or combinations thereof. In other exemplary embodiments, the electrolyte comprises a polymer comprising a polyethylene oxide; and an alkaline agent comprising LiOH, NaOH, KOH, CsOH, RbOH, or combinations thereof. For example, the electrolyte comprises a polymer comprising a polyethylene oxide and an alkaline agent comprising KOH.

In several exemplary embodiments, the electrolyte of the present invention comprises more than about 1 wt % of alkaline agent (e.g., more than about 5 wt % of alkaline agent, or from about 5 wt % to about 76 wt % of alkaline agent). In one example, the electrolyte comprises a liquid polymer comprising a polyethylene oxide and 3 wt % or more (e.g., 4 wt % or more, from about 4 wt % to about 33 wt %, or from about 5 wt % to about 15 wt %) of an alkaline agent. For instance, the electrolyte comprises polyethylene oxide and 5 wt % or more of KOH. In another example, the electrolyte consists essentially of a polyethylene oxide having a molecular weight or mean molecular weight from about 100 amu to about 1000 amu and 5 wt % or more of KOH.

Electrolytes of the present invention can be substantially free of water. In several embodiments, the electrolyte comprises water in an amount of about 60 wt % or less (e.g., about 50 wt % or less, about 40 wt % or less, about 30 wt % or less, about 25 wt % or less, about 20 wt % or less, or about 10 wt % or less).

Also, electrolytes of the present invention can optionally comprise a small amount of a small carbon chain alcohol. For example, the electrolyte comprises less than about 10 wt % by weight of electrolyte (e.g., less than about 5 wt % by weight of electrolyte or less than about 1 wt % by weight of electrolyte) of a small carbon chain alcohol such as methanol, ethanol, isopropanol, or mixtures thereof.

Electrolytes of the present invention are useful in many electrochemical devices such as those of the present invention (e.g., zinc-silver batteries).

### III. ELECTROCHEMICAL CELL

Another aspect of the present invention provides an electrochemical cell including a cathode comprising a silver oxide powder (e.g., AgO, Ag₂O₃, Ag₂O. or any combination thereof) an anode comprising Zn, and any of the electrolytes described above.

A. Electrodes

Cathodes useful in electrochemical cells of the present invention comprise silver oxide (e.g., AgO, Ag₂O₃, Ag₂O. or any combination thereof). For instance, the cathode comprises silver oxide (e.g., AgO, Ag₂O₃, or any combination thereof) and a binder. Cathodes can comprise silver oxide powder that is coated and/or doped with an organic lead additive (e.g., lead acetate), or they can essentially consist of silver oxide powder.

Anodes useful in electrochemical cells of the present invention comprise Zn. For instance, the anode comprises Zn and a binder.

In one embodiment, the electrochemical cell comprises a cathode comprising silver oxide powder and a first binder; and an anode comprising zinc and a second binder, wherein the silver oxide powder is doped with a first lead compound sufficient to provide the cathode with a resistivity of about 15 Ohm·cm or less (e.g., about 10 Ohm·cm or less, about 9 Ohm·cm or less, about 8 Ohm·cm or less, about 6 Ohm—cm or less, or about 5 Ohm·cm or less).

In several embodiments, the cathode of the electrochemical cell comprises silver oxide (e.g., AgO, Ag₂O₃, or any combination thereof).

Cathodes and anodes of electrochemical cells of the present invention can optionally include additives such as a binder, a current collector, dopants, coatings, or the like. The binder of the cathode and the binder of the anode can include the same material or different materials. In one example, the binder of the anode or the cathode comprises PTFE, PVDF, or any copolymer thereof.

Electrochemical cells of the present invention can comprise any suitable electrolyte. For example, the electrochemical cell comprises an electrolyte that includes aqueous NaOH or KOH. In other examples, the electrolyte comprises a mixture of NaOH or KOH and a liquid PEO polymer.

In other embodiments, the cathode comprises AgO powder and a binder that is selected from PTFE, PVDF, or a copolymer thereof. And, in some embodiments, the cathode comprises Ag₂O₃ powder and a binder that is selected from PTFE, PVDF, or a copolymer thereof.

In some embodiments, the anode comprises Zn, a binder that is selected from PTFE, PVDF, or a copolymer thereof.

B. Separators

Electrochemical cells of the present invention additionally comprise a separator that separates the anode from the cathode.

Separators of the present invention can comprise a film having a single layer or a plurality of layers, wherein the plurality of layers may comprise a single polymer (or copolymer) or more than one polymer (or copolymer).

In several embodiments, the separators comprise a unitary structure formed from at least two strata. The separator can include strata wherein each layer comprises the same material, or each layer comprises a different layer, or the strata are layered to provide layers of the same material and at least on layer of another material. In several embodiments, one stratum comprises an oxidation resistant material, and the remaining stratum comprises a dendrite resistant material. In other embodiments, at least one stratum comprises an oxidation-resistant material, or at least one stratum comprises a dendrite-resistant material. The unitary structure is formed when the material comprising one stratum (e.g., an oxidation-resistant material) is coextruded with the material comprising another stratum (e.g., a dendrite resistant material or oxidation-resistant material). In several embodiments, the unitary separator is formed from the coextrusion of oxidation-resistant material with dendrite-resistant material.

In several embodiments, the oxidation-resistant material comprises a polyether polymer mixture and the dendrite resistant material comprises a PVA polymer mixture.

It is noted that separators useful in electrochemical cells can be configured in any suitable way such that the separator is substantially inert in the presence of the anode, cathode, and electrolyte of the electrochemical cell. For example, a separator for a rectangular battery electrode may be in the form of a sheet or film comparable in size or slightly larger than the electrode, and may simply be placed on the electrode or may be sealed around the edges. The edges of the separator may be sealed to the electrode, an electrode current collector, a battery case, or another separator sheet or film on the backside of the electrode via an adhesive sealant, a gasket, or fusion (heat sealing) of the separator or another material. The separator may also be in the form of a sheet or film wrapped and folded around the electrode to form a single layer (front and back), an overlapping layer, or multiple layers. For a cylindrical battery, the separator may be spirally wound with the electrodes in a jelly-roll configuration. Typically, the separator is included in an electrode stack comprising a plurality of separators. The oxidation-resistant separator of the invention may be incorporated in a battery in any suitable configuration.

1. Polyether Polymer Material

In several embodiments of the present invention the oxidation-resistant stratum of the separator comprises a polyether polymer material that is coextruded with a dendrite-resistant material. The polyether material can comprise polyethylene oxide (PEO) or polypropylene oxide (PPO), or a copolymer or a mixture thereof. The polyether material may also be copolymerized or mixed with one or more other polymer materials, polyethylene, polypropylene and/or polytetrafluoroethylene (PTFE), for example. In some embodiments, the PE material is capable of forming a free-standing polyether film when extruded alone, or can form a free standing film when coextruded with a dendrite-resistant material. Furthermore, the polyether material is substantially inert in the alkaline battery electrolyte and in the presence of silver ions.

In alternative embodiments, the oxidation resistant material comprises a PE mixture that optionally includes zirconium oxide powder. Without intending to be limited by theory, it is theorized that the zirconium oxide powder inhibits silver ion transport by forming a surface complex with silver ions. The term “zirconium oxide” encompasses any oxide of zirconium, including zirconium dioxide and yttria-stabilized zirconium oxide. The zirconium oxide powder is dispersed throughout the PE material so as to provide a substantially uniform silver complex and a uniform barrier to transport of silver ions. In several embodiments, the average particle size of the zirconium oxide powder is in the range from about 1 nm to about 5000 nm, e.g., from about 5 nm to about 100 nm.

In other embodiments, the oxidation-resistant material further comprises an optional conductivity enhancer. The conductivity enhancer can comprise an inorganic compound, potassium titanate, for example, or an organic material. Titanates of other alkali metals than potassium may be used. Suitable organic conductivity enhancing materials include organic sulfonates and carboxylates. Such organic compounds of sulfonic and carboxylic acids, which may be used singly or in combination, comprise a wide range of polymer materials that may include salts formed with a wide variety of electropositive cations, K⁺, Na⁺, Li⁺, Pb⁺², Ag⁺, NH4⁺, Ba⁺², Sr⁺², Mg⁺², Ca⁺² or anilinium, for example. These compounds also include commercial perfluorinated sulfonic acid polymer materials, Nafion® and Flemion®, for example. The conductivity enhancer may include a sulfonate or carboxylate copolymer, with polyvinyl alcohol, for example, or a polymer having a 2-acrylamido-2-methyl propanyl as a functional group. A combination of one or more conductivity enhancing materials can be used.

Oxidation-resistant material that is coextruded to form a separator of the present invention can comprise from about 5 wt % to about 95 wt % (e.g., from about 20 wt % to about 60 wt %, or from about 30 wt % to about 50 wt %) of zirconium oxide and/or conductivity enhancer.

Oxidation-resistant materials can also comprise additives such as surfactants that improve dispersion of the zirconium oxide powder by preventing agglomeration of small particles. Any suitable surfactant may be used, including one or more anionic, cationic, non-ionic, ampholytic, amphoteric and zwitterionic surfactants, and mixtures thereof. In one embodiment, the separator comprises an anionic surfactant. For example, the separator comprises an anionic surfactant, and the anionic surfactant comprises a salt of sulfate, a salt of sulfonate, a salt of carboxylate, or a salt of sarcosinate. One useful surfactant comprises p-(1,1,3,3-tetramethylbutyl)-phenyl ether, which is commercially available under the trade name Triton X-100 from Rohm and Haas.

In several embodiments, the oxidation-resistant material comprises from about 0.01 wt % to about 1 wt % of surfactant.

2. Polyvinyl Polymer Material

In several embodiments of the present invention the dendrite-resistant stratum of the separator comprises a polyvinyl polymer material that is coextruded with the oxidation-resistant material. In several embodiments, the PVA material comprises a cross-linked polyvinyl alcohol polymer and a cross-linking agent.

In several embodiments, the cross-linked polyvinyl alcohol polymer is a copolymer. For example, the cross-linked PVA polymer is a copolymer comprising a first monomer, PVA, and a second monomer. In some instances, the PVA polymer is a copolymer comprising at least 60 mole percent of PVA and a second monomer. In other examples, the second monomer comprises vinyl acetate, ethylene, vinyl butyral, or any combination thereof.

PVA material useful in separators of the present invention also comprise a cross-linking agent in a sufficient quantity as to render the separator substantially insoluble in water. In several embodiments, the cross-linking agent used in the separators of the present invention comprises a monoaldehyde (e.g., formaldehyde or glyoxilic acid); aliphatic, furyl or aryl dialdehydes (e.g., glutaraldehyde, 2,6 furyldialdehyde or terephthaldehyde); dicarboxylic acids (e.g., oxalic acid or succinic acid); polyisocyanates; methylolmelamine; copolymers of styrene and maleic anhydride; germaic acid and its salts; boron compounds (e.g., boron oxide, boric acid or its salts; or metaboric acid or its salts); or salts of copper, zinc, aluminum or titanium. For example, the cross-linking agent comprises boric acid.

In another embodiment, the PVA material optionally comprises zirconium oxide powder. In several embodiments, the PVA material comprises from about 1 wt % to about 99 wt % (e.g., from about 2 wt % to about 98 wt %, from about 20 wt % to about 60 wt %, or from about 30 wt % to about 50 wt %).

In many embodiments, the dendrite-resistant strata of the separator of the present invention comprises a reduced ionic conductivity. For example, in several embodiments, the separator comprises an ionic resistance of less than about 20 mΩ/cm², (e.g., less than about 10 mΩ/cm², less than about 5 mΩ/cm², or less than about 4 mΩ/cm²).

The PVA material that forms the dendrite-resistant stratum of the separator of the present invention can optionally comprise any suitable additives such as a conductivity enhancer, a surfactant, a plasticizer, or the like.

In some embodiments, the PVA material further comprises a conductivity enhancer. For example, the PVA material comprises a cross-linked polyvinyl alcohol polymer, a zirconium oxide powder, and a conductivity enhancer. The conductivity enhancer comprises a copolymer of polyvinyl alcohol and a hydroxyl-conducting polymer. Suitable hydroxyl-conducting polymers have functional groups that facilitate migration of hydroxyl ions. In some examples, the hydroxyl-conducting polymer comprises polyacrylate, polylactone, polysulfonate, polycarboxylate, polysulfate, polysarconate, polyamide, polyamidosulfonate, or any combination thereof. A solution containing a copolymer of a polyvinyl alcohol and a polylactone is sold commercially under the trade name Vytek® polymer by Celanese, Inc. In several examples, the separator comprises from about 1 wt % to about 10 wt % of conductivity enhancer.

In other embodiments, the PVA material further comprises a surfactant. For example, the separator comprises a cross-linked polyvinyl alcohol polymer, a zirconium oxide powder, and a surfactant. The surfactant comprises one or more surfactants selected from an anionic surfactant, a cationic surfactant, a nonionic surfactant, an ampholytic surfactant, an amphoteric surfactant, and a zwitterionic surfactant. Such surfactants are commercially available. In several examples, the PVA material comprises from about 0.01 wt % to about 1 wt % of surfactant.

In several embodiments, the dendrite-resistant stratum further comprises a plasticizer. For example, the dendrite-resistant stratum comprises a cross-linked polyvinyl alcohol polymer, a zirconium oxide powder, and a plasticizer. The plasticizer comprises one or more plasticizers selected from glycerin, low-molecular-weight polyethylene glycols, aminoalcohols, polypropylene glycols, 1,3 pentanediol branched analogs, 1,3 pentanediol, and/or water. For example, the plasticizer comprises greater than about 1 wt % of glycerin, low-molecular-weight polyethylene glycols, aminoalcohols, polypropylene glycols, 1,3 pentanediol branched analogs, 1,3 pentanediol, or any combination thereof, and less than about 99 wt % of water. In other examples, the plasticizer comprises from about 1 wt % to about 10 wt % of glycerin, low-molecular-weight polyethylene glycols, aminoalcohols, polypropylene glycols, 1,3 pentanediol branched analogs, 1,3 pentanediol, or any combination thereof, and from about 99 wt % to about 90 wt % of water.

In some embodiments, the separator of the present invention further comprises a plasticizer. In other examples, the plasticizer comprises glycerin, a low-molecular-weight polyethylene glycol, an aminoalcohol, a polypropylene glycols, a 1,3 pentanediol branched analog, 1,3 pentanediol, or combinations thereof, and/or water.

Separators useful for the present invention can comprise a unitary structure that includes a plurality of layers. Some of these layers can comprise PEO material, as described above, and several of these can comprise PVA material, as described above, and some unitary structures can comprise both materials. Sometimes the PVA material and the PEO material are coextruded, e.g., using a slotted die or other apparatus, into a free standing separator or are coextruded onto a substrate, e.g., a commercially available substrate such as Solupor, Scimat, or the like, to form a supported separator.

### IV. METHODS

Another aspect of the present invention provides methods of producing an electrolyte comprising providing at least one polymer comprising PEG; providing at least one alkaline agent; combining the polymer and the alkaline agent to generate a mixture

wherein the mixture has a glass transition temperature of at least −20° C.

In some embodiments, the method further comprises providing less than about 10 wt % by weight of electrolyte of a small carbon chain alcohol such as any of the small carbon chain alcohols described above.

Polymers and alkaline agents useful in the present methods include any polymers and alkaline agents describe above.

Another aspect of the present invention provides methods of manufacturing an electrochemical cell comprising providing a cathode, providing an anode, and providing an electrolyte; wherein the cathode comprises silver oxide, the anode comprises Zn, and the electrolyte comprises a liquid polymer (e.g., PEG) and an alkaline agent.

Another aspect of the present invention provides methods of manufacturing an electrochemical device comprising providing a cathode, providing an anode, and providing an electrolyte as described above; wherein the cathode comprises silver oxide (e.g., AgO or Ag₂O₃) and the anode comprises Zn.

### VI. EXAMPLES

In the examples below, several exemplary electrolytes of the present invention are described. Several of these exemplary electrolytes are evaluated by incorporating them into test electrochemical cells of the present invention, which are described and evaluated below. It is noted that these test cells are intended to be non-limiting examples of electrochemical cells of the present invention.

### Example 1

### Exemplary Electrolytes

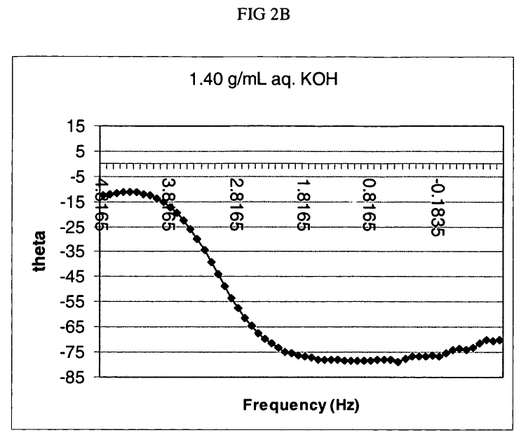

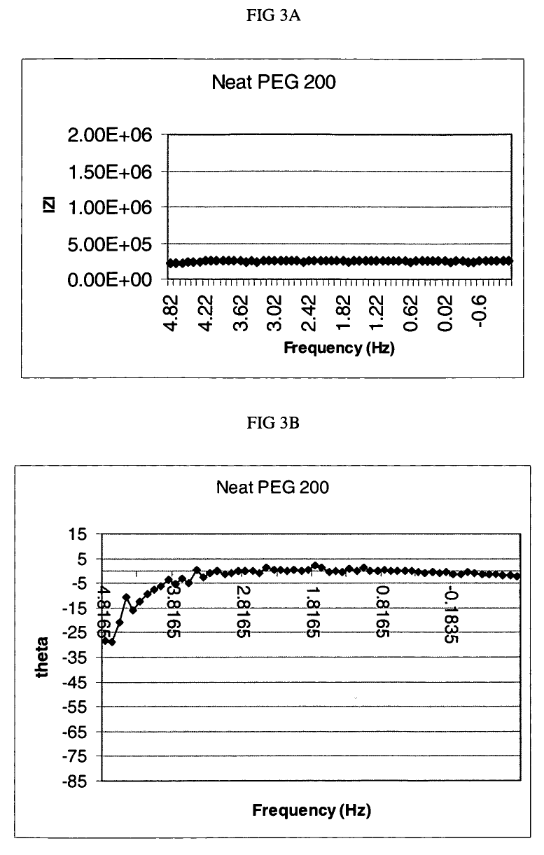

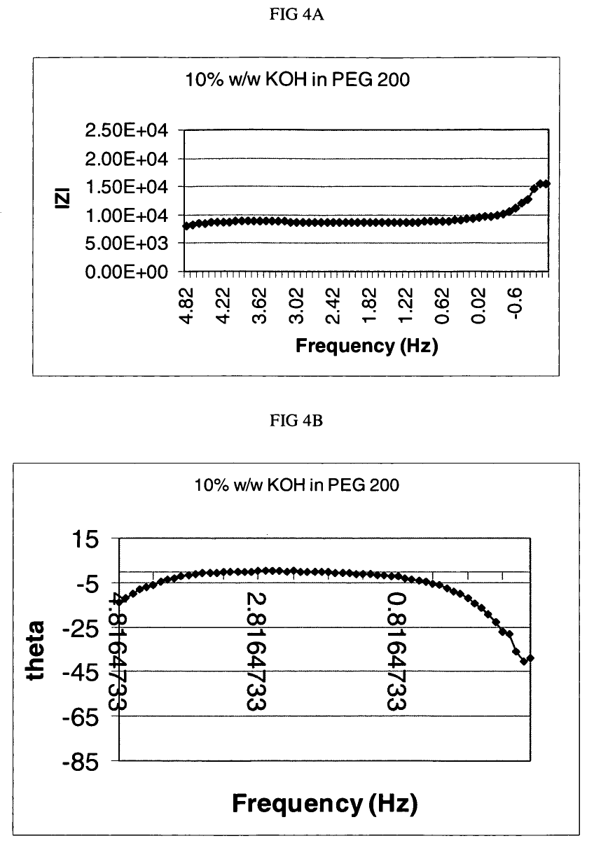

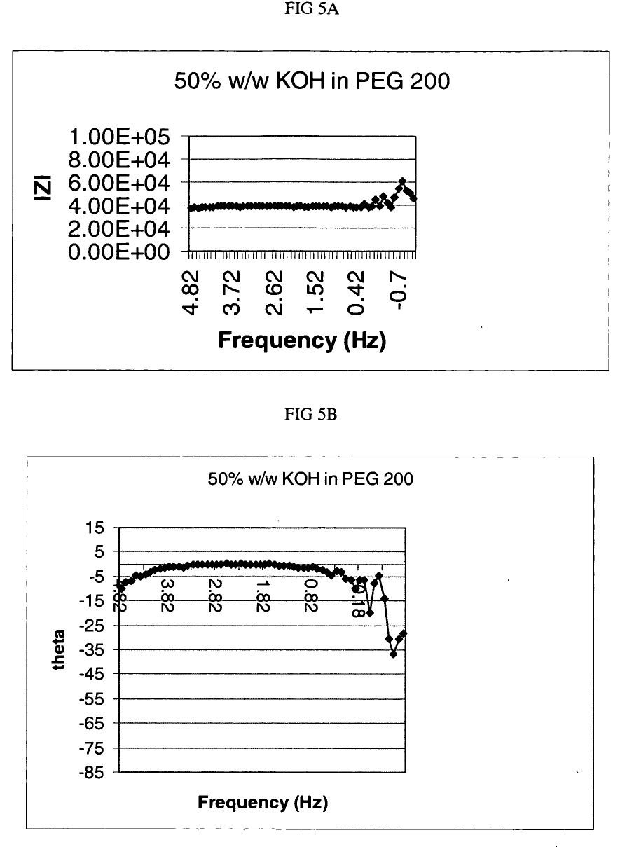

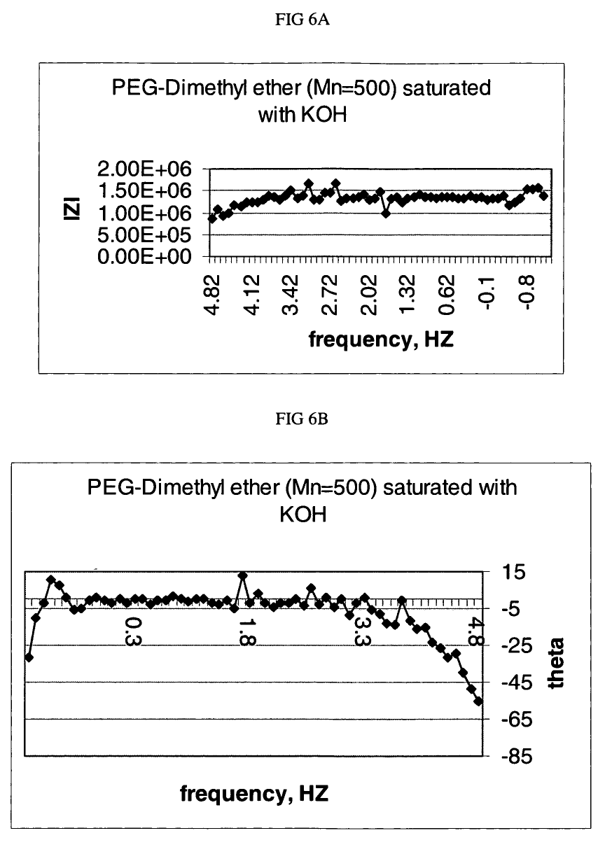

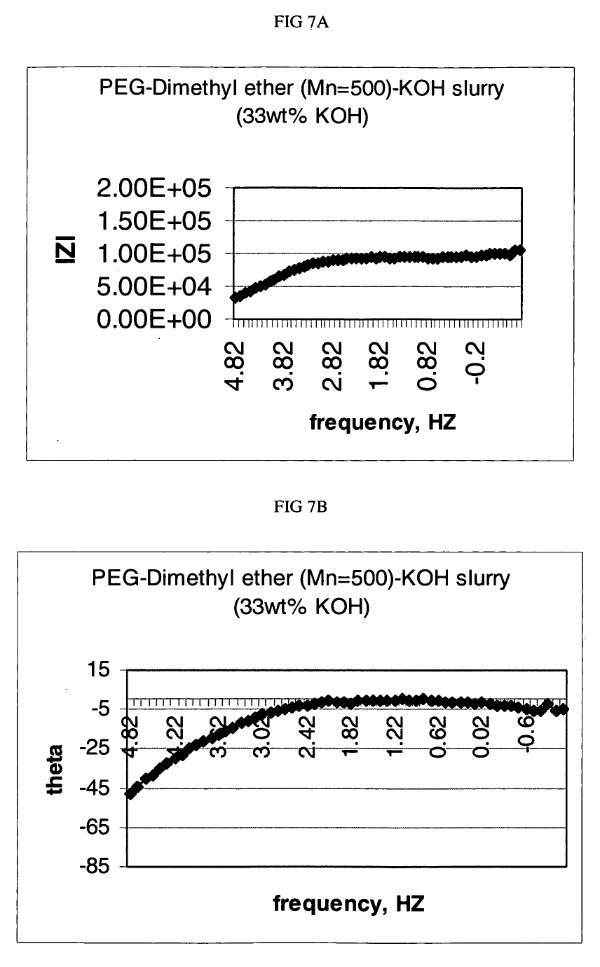

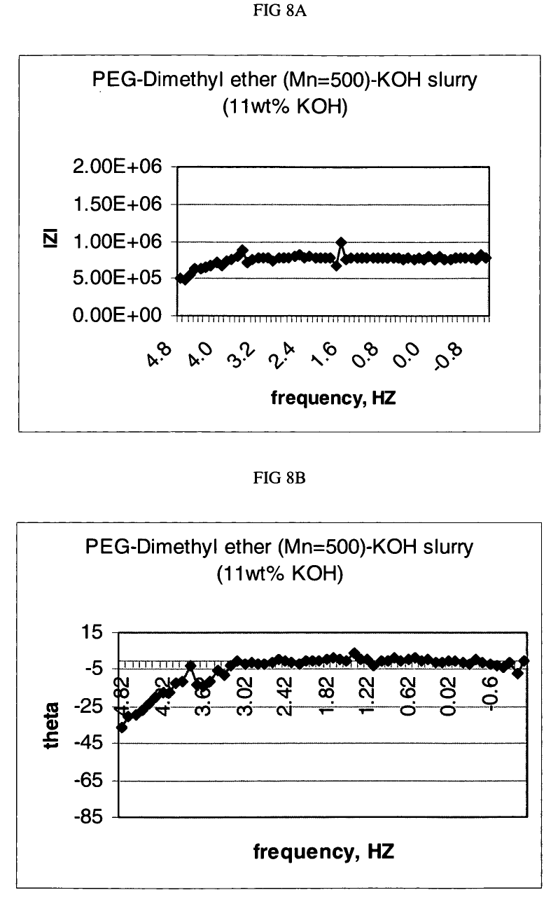

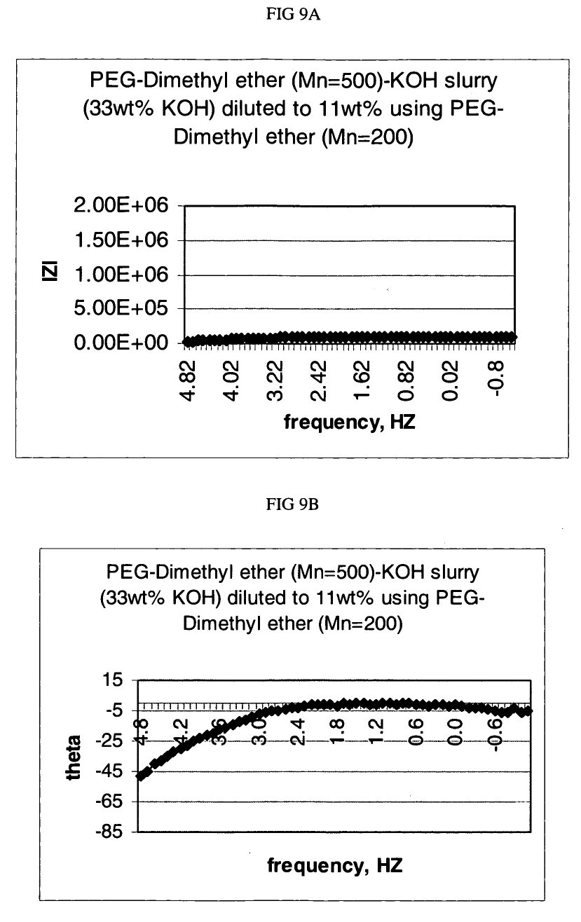

The ionic conductivities of the following polymer electrolytes are provided accordingly:

| Sample No. | Electrolyte: | Ionic Conductivity |
|---|---|---|
| 1 | 1.4 g/mL of KOH | SEE FIGS. 2A and 2B |
| 2 | Neat PEG-200 | SEE FIGS. 3A and 3B |
| 3 | PEG-200 and 10 wt % KOH | SEE FIGS. 4A and 4B |
| 4 | PEG-200 and 50 wt % KOH | SEE FIGS. 5A and 5B |
| 5 | PEG-dimethyl ether (Mn = | SEE FIGS. 6A and 6B |
| | 500 amu) saturated with | |
| | KOH | |
| 6 | PEG-dimethyl ether (Mn = | SEE FIGS. 7A and 7B |
| | 500 amu) and 33 wt % KOH | |
| 7 | PEG-dimethyl ether (Mn = | SEE FIGS. 8A and 8B |
| | 500 amu) and 11 wt % KOH | |
| 8 | PEG-dimethyl ether (Mn = | SEE FIGS. 9A and 9B |
| | 500 amu) and 33 wt % KOH | |
| | that is diluted to 11 wt % of | |
| | KOH with PEG 200 | |

KOH pellets were added to polyethylene glycols of varying molecular weights (various amounts). The mixtures were stirred for times varying from a few hours to several days, giving solutions varying in color from golden yellow to a very dark black/brown.

### Example No. 2

### Anodes Used in Test Cells for the Evaluation of Polymer Electrolyte

Materials
Zn powder (GN-10, Grillo-werke, German)
ZnO powder (Sigma-Aldrich, USA)
Bi₂O₃ powder (99.975% [metal basis], Alfa Aesar, USA)
Poly (vinylidene fluoride-co-hexafluoropropylene) (PVDF-co-HFP) pellet (Mn=130,000, Mw=400,000, Sigma-Aldrich, Usa)
Acetone (99.5+% ACS reagent, Sigma-Aldrich, USA)

Procedures

(1) Prepare the PVDF-co-HFP solution:

The PVDF-co-HFP was dissolved in acetone (weight ratio—PVDF-co-HFP: acetone=1:7 to 1:11)

(2) Dry powder mixing:

Any ZnO agglomerates were manually broken down and mixed with Bi₂O₃, ZnO and Zn (GN-10) in desired amounts using a Flectek mixer at 1000 rpm for 1 to 2 minutes

(3) The solution from (1) with the desired binder content was added to the mixture of dry powders from (2) and mixed in the Flecteck mixer at 1000 rpm for 2 minutes to generate a slurry

(4) The slurry from (3) was manually mixed with a stainless spoon to produce a uniform slurry, which was quickly poured into a clean glass plate and air dried

(5) The dried film was peeled from the glass plate and resized using a die punch to obtain the desired dimension of the zinc anode

(6) A desired amount of anode material was weighed (See Table 1);

(7) Anode material was added to a mold, an anode current collector was added, and more anode material was placed on top of the collector, the mold was pressed at 5 tons for 30 seconds to produce a zinc anode.

These procedures were followed to produce anodes having formulations according to Table 1 below:

TABLE 1
Exemplary zinc anode formulations.

| | 5% | 3% | 2% |
|---|---|---|---|
| Materials | PVDF-co-HFP | PVDF-co-HFP | PVDF-co-HFP |
| Zn (g) | 87.77 | 89.63 | 90.56 |
| ZnO (g) | 6.76 | 6.90 | 6.97 |
| Bi₂O₃ (g) | 0.47 | 0.47 | 0.47 |
| PVDF-co-HFP | 5.00 | 3.00 | 2.00 |
| (g) | | | |

### Example No. 3

### Cathodes Used in Test Cells for the Evaluation of Polymer Electrolyte

To a 20 wt % suspension of AgO in de-ionized, a 2.6 wt % lead acetate trihydrate solution was slowly added under stirring. The mixture was allowed to settle, and the water was decanted. The residue was re-suspended with de-ionized water. This process was repeated several times and then filtered to generate a wet filtrate, which was dried in vacuum oven at 60° C. This process was performed using sufficient amounts of starting materials to generate approximately 100 g of 1.3 wt % Pb-coated AgO, which is the cathode active material used in the test cells described below.

28.09 g of a 5.2 wt % PTFE solution (DuPont 3859) was added to 73 g of 1.3 wt % Pb-coated AgO in a Flack-tek mixing cup. The components were homogenized in a Flack-tek centrifugal mixer. The cathode dough was rolled out thickness of 2.5 mm. Individual cathode cookies, 43×31 mm in area, are cut from the rolled dough. The cookies were then vacuumed dried at 60° C. for 3 hours. The dried cookies were further rolled to 1.1 mm in thickness and then trimmed to 41×29 mm in area. Lastly, the cookies were pressed onto a 0.6 g silver expanded metal current collector (41×29 mm area) with 5.5 tons of force. The final cathodes were 0.9 mm thick and weighed 4.9 g including the current collector.

### Example No. 4

### Separators Used in Test Cells for the Evaluation of Polymer Electrolyte

A separator formed from 2 layers of PVA material was formulated to include:

| | |
|---|---|
| Yittria Stabilized Zirconium Oxide (Hicharms) | 4.4 w % |
| Polyvinyl Alcohol (Dupont Elvanol) | 7.4 w % |
| Boric Acid (Aldrich) | 0.2 w % |
| Deionized Water | 88 w % |

Each of the ingredients was mixed and cast in a glass tray such that the final dry thickness was approximately 40 microns. Two layers of the dried PVA material were stacked to form a unitary separator having a thickness of approximately 80 microns.

A separator comprising a PEO layer was formulated from:

| | |
|---|---|
| Polyethylene oxide (Alkox) | 3.7 w % |
| Deionized Water | 70.6 w % |
| Potassium Titanate (Mintchem Group) | 0.9 w % |
| Colloidal Zirconium Oxide (Alfa Aesar) | 24.8 w % |
| Triton X-100 (Aldrich) | 3 drops |

Each of these ingredients was mixed and cast onto a 25 micron porous polyolefin substrate (i.e. Solupor, DSM Solutech) to give a final dry thickness of about 45 microns.

### Example No. 5

### Test Cells A and B Used for the Evaluation of Polymer Electrolyte

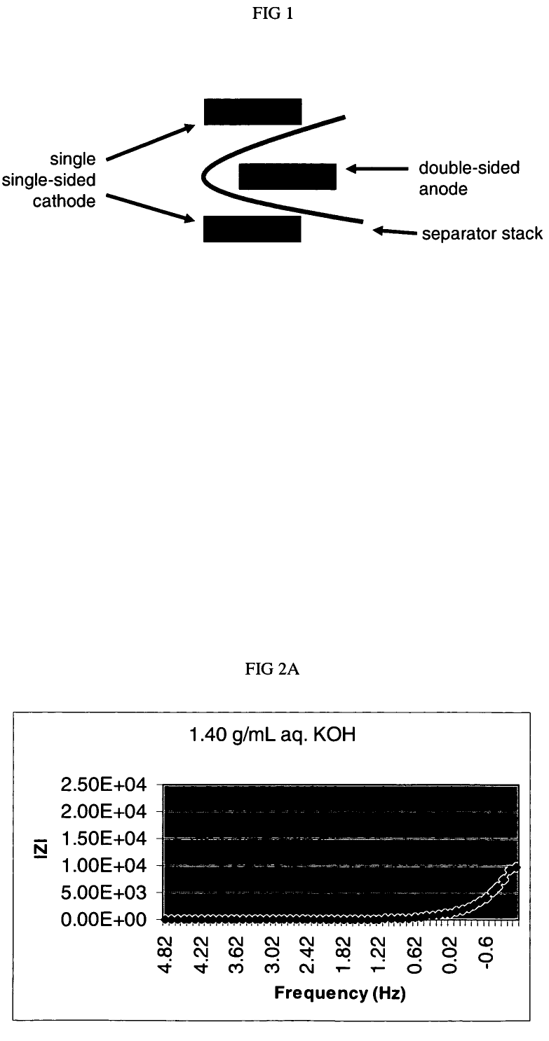

In this example, the charge and discharge profiles and the state of oxidation of the electrode separators in each of two cells (Cell A and Cell B) were evaluated. An illustration of the cell stack used for Cells A and B is provided in FIG. 1.

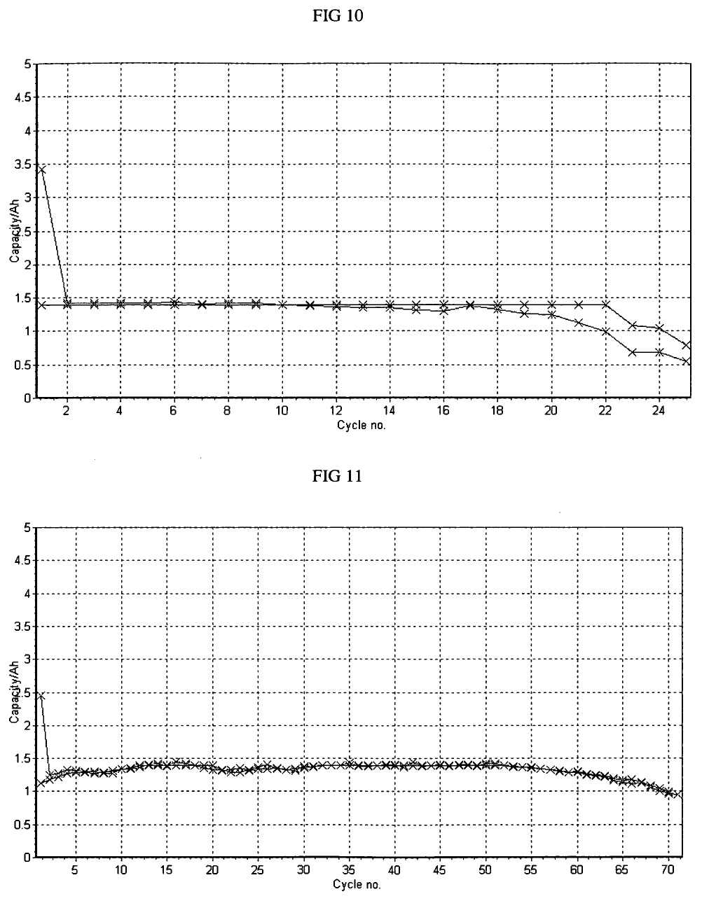

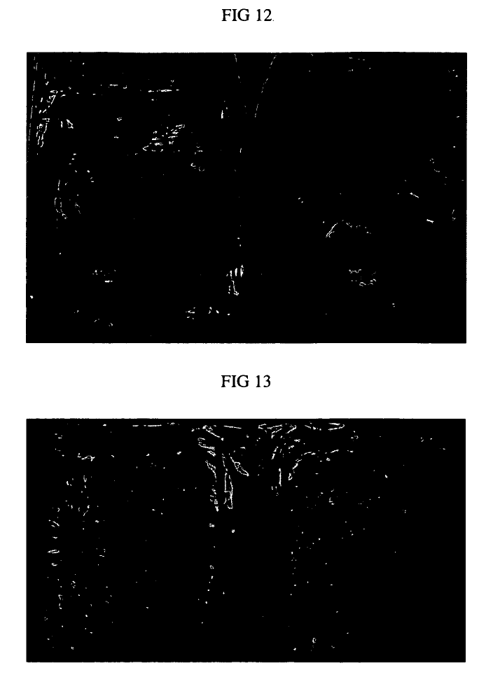

In Cell A, silver (about 10 grams total) and zinc (about 7 grams total) electrodes were wrapped in separate Solupor films, which are commercially available from DSM Solutech. A separator comprising 2 layers of PVA material, as described in Example 4, was used to separate the electrodes. The electrode assembly was placed in a polyethylene envelope and charged with 0.5 mL of 40 wt % KOH solution, and vacuum sealed. The charge and discharge profile of Cell A is presented below in FIG. 10, and a picture of the PVA separator is also provided in FIG. 12.

In Cell B, the silver (about 10 grams total) electrodes are dip-coated in the PEG electrolyte paste and dried under a nitrogen atmosphere to afford a coating of about 10 microns thick. The silver and zinc (about 7 grams total of zinc anode material) electrodes were wrapped in separate Solupor films, which are commercially available from DSM Solutech. Two layers of polyvinyl alcohol film were used as the separator, as described in Example 4. The electrode assembly was placed in a polyethylene envelope and charged with 0.5 mL of 40 wt % KOH solution and vacuum sealed. The charge and discharge profile of Cell B is presented below in FIG. 11, and a picture of the PVA separator is also provided in FIG. 13.

Note that the KOH/PEG electrolyte was prepared by mixing KOH, PEG, zirconium oxide, and water, in a 1:2:2:4 ratio, in a mechanical agitator to afford a viscous paste.

Referring to FIGS. 12 and 13, a study of the test Cells A and B, at the end of the life cycle test, demonstrated that the separator layer closest to the silver electrodes in test Cell B is largely un-oxidized, as observed by the nearly colorless film found after about 70 charge cycles. However, the separator layer in test Cell A is extensively oxidized, as observed by the extreme discoloration in the separator. This effect is common in Ag/Zn rechargeable battery technology where there is deficiency in the control of soluble silver species migration in the cell. As a result, the mechanical properties of the separator deteriorate under oxidation with cycling, rendering a short-lived Ag/Zn cell. Thus, it is demonstrated that the PEG electrolyte used in Cell B prolongs cycle life in secondary batteries.

### Other Embodiments

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. An electrolyte comprising:
a polymer comprising PEG; and
an alkaline agent,
wherein the electrolyte has a glass transition temperature of at least about −20° C., and the polymer and the alkaline agent are substantially miscible.

2. The electrolyte of claim 1, wherein the polymer comprises PEG having a mean molecular mass of from about 100 amu to about 10,000 amu.

3. The electrolyte of claim 1, wherein the polymer comprises a polymer of formula (I): 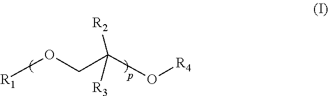
wherein
Each of R₂ and R₃ is independently —(V₁-Q₁)ₙ-H, wherein
Each V₁ is independently a bond or —O—,
Each Q₁ is independently a bond or a C₁₋₆ alkylidene, and
Each n is independently 1-5;
Each of R₁ and R₄ is independently -(Q₂-V₂-Q₃)ₙ-H, wherein
Each Q₂ is independently a C₁₋₆ alkylidene,
Each V₂ is independently a bond or —O—, and
Each Q₃ is independently a bond or a C₁₋₆ alkylidene; and
p is a positive integer of sufficient value such that the polymer of formula (I) has a total molecular weight of from about 100 amu to about 10,000 amu.

4. The electrolyte of claim 3, wherein R₁ is -(Q₂-V₂-Q₃)ₙ-H, n is 1, each of V₂, Q₂, and Q₃ is a bond.

5. The electrolyte of claim 4, wherein R₄ is -(Q₂-V₂-Q₃)ₙ-H, n is 1, each of V₂, Q₂, and Q₃ is a bond.

6. The electrolyte of claim 3, wherein R₁ is -(Q₂-V₂-Q₃)ₙ-H, n is 1, each of Q₂ and V₂ is a bond, and Q₃ is —CH₂—.

7. The electrolyte of claim 1, wherein the electrolyte has a glass transition temperature of at least −15° C.

8. The electrolyte of claim 7, wherein the polymer comprises polyethylene glycol, polypropylene glycol, polybutylene glycol, alkyl-polyethylene glycol, alkyl-polypropylene glycol, alkyl-polybutylene glycol, a copolymer thereof, or any combination thereof.

9. The electrolyte of claim 8, wherein the alkaline agent comprises LiOH, NaOH, KOH, CsOH, RbOH, or any combination thereof.

10. The electrolyte of claim 9, further comprising from about 5 wt % to about 76 wt % of alkaline agent.

11. The electrolyte of claim 10, wherein the alkaline agent further comprises KOH.

12. The electrolyte of claim 11, wherein the electrolyte is substantially free of water.

13. The electrolyte of claim 11, further comprising an amount of water that equals about 60% of the wt of the alkaline agent or less.

14. The electrolyte of claim 8, further comprising less than about 10 wt % by weight of electrolyte of a small carbon chain alcohol.

15. An electrochemical cell comprising:
a cathode comprising silver oxide;
an anode comprising Zn; and
a liquid electrolyte comprising
a polymer comprising PEG, and
an alkaline agent,
wherein the polymer and the alkaline agent are substantially miscible.

16. The cell of claim 15, wherein the polymer comprising PEG has a mean molecular mass of from about 100 amu to about 10,000 amu.

17. The cell of claim 15, wherein the polymer comprises a polymer of formula (I): 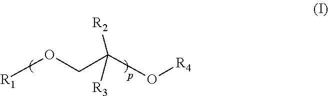
wherein
Each of R₂ and R₃ is independently -(V₁-Q₁)ₙ-H, wherein
Each V₁ is independently a bond or —O—,
Each Q₁ is independently a bond or a C₁₋₆ alkylidene, and
Each n is independently 1-5;
Each of R₁ and R₄ is independently -(Q₂-V₂-Q₃)ₙ-H, wherein
Each Q₂ is independently a C₁₋₆ alkylidene,
Each V₂ is independently a bond or —O—, and
Each Q₃ is independently a bond or a C₁₋₆ alkylidene; and
p is a positive integer of sufficient value such that the polymer of formula (I) has a total molecular weight of from about 100 amu to about 10,000 amu.

18. The cell of claim 17, wherein R₁ is -(Q₂-V₂-Q₃)ₙ-H, n is 1, each of V₂, Q₂, and Q₃ is a bond.

19. The cell of claim 18, wherein R₄ is -(Q₂-V₂-Q₃)ₙ-H, n is 1, and each of V₂, Q₂, and Q₃, is a bond.

20. The cell of claim 17, wherein R₁ is -(Q₂-V₂-Q₃)ₙ-H, n is 1, each of Q₂ and V₂ is a bond, and Q₃ is —CH₂—.

21. The cell of claim 17, wherein the electrolyte has a glass transition temperature of at least at least −15° C.

22. The cell of claim 21, wherein the polymer comprises polyethylene glycol, polypropylene glycol, polybutylene glycol, alkyl-polyethylene glycol, alkyl-polypropylene glycol, alkyl-polybutylene glycol, a copolymer thereof, or any combination thereof.

23. The cell of claim 22, wherein the alkaline agent comprises LiOH, NaOH, KOH, CsOH, RbOH, or a combination thereof.

24. The cell of claim 23, wherein the electrolyte further comprises more than about 5 wt % of alkaline agent.

25. The cell of claim 25, wherein the electrolyte further comprises from about 4 wt % to about 33 wt % of alkaline agent.

26. The cell of claim 26, wherein the alkaline agent further comprises KOH.

27. The cell of claim 16, wherein the anode, the cathode, or both further comprise a binder comprising PVDF, PTFE, or a copolymer thereof.

28. The cell of claim 27, further comprising a separator that is substantially inert in the presence of the electrolyte, cathode, and anode.

29. The cell of claim 28, wherein the separator comprises a polyacid, a polyalcohol, a polyamine, a polysulfonate, or a combination thereof.

30. The cell of claim 29, wherein the separator comprises a PEO material or a PVA material.

31. The cell of claim 26, wherein the electrolyte comprises an amount of water totaling about 60 wt % or less by wt of electrolyte.

32. A method of producing an electrolyte comprising:
providing at least one polymer comprising PEG;
providing at least one alkaline agent;
combining the polymer and the alkaline agent to generate a mixture
wherein the mixture has a glass transition temperature of at least −20° C.

33. The method of claim 32, further comprising providing about 10 wt % by weight of electrolyte of a small carbon chain alcohol.

34. (canceled)
